(19) United States
(12) Patent Application Publication
(10) Pub. No.: US 2007/0182309 A1
(43) Pub. Date: Aug. 9, 2007

(54) PHOSPHOR, FLUORESCENT GEL, AND LIGHT EMITTING DIODE DEVICE

(75) Inventors: Sheng-Min Wang, Miao-Li County (TW); Chien-Min Wang, Miao-Li County (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/566,811

(22) Filed: Dec. 5, 2006

(30) Foreign Application Priority Data
Feb. 7, 2006 (TW) 95104019

(51) Int. Cl. H01J 1/62; H01J 63/04

(52) U.S. Cl. 313/486; 313/512

(57) ABSTRACT

A phosphor is provided. The chemical formula of the phosphor is Me₃₋ₐYO_{5-b}X_{b}:aCe, the Me is one of calcium (Ca), strontium (Sr), barium (Ba), europium (Eu), terbium (Tb), or the combination thereof; Y is one of silicon (Si), boron (B), aluminum (Al), or the combination thereof; X is fluorine (F), chlorine (Cl), bromine (Br), or nitrogen (N); coefficient a is between 0.001 and 0.5; coefficient b is between 0 and 5. Besides, a fluorescent gel and a light emitting diode device including the phosphor are provided.

### CROSS-REFERENCE TO RELATED APPLICATION

This application claims the priority benefit of Taiwan application serial no. 95104019, filed on Feb. 7, 2006. All disclosure of the Taiwan application is incorporated herein by reference.

### BACKGROUND OF THE INVENTION

1. Field of the Invention

The present invention relates to a light emitting material and a light emitting device including the light emitting material. More particularly, the present invention relates to a phosphor, a fluorescent gel, and a light emitting diode.

2. Description of Related Art

Generally speaking, white LED light source device is formed by a lead frame, a blue LED chip, and a fluorescent gel. The blue LED chip is disposed on the lead frame and is electrically connected to the lead frame. The blue LED chip is an InGaN-based LED chip, and the LED chip is suitable for emitting blue light. The fluorescent gel covers the blue LED chip. The fluorescent gel contains yellow phosphor, and the material thereof is YAG:Ce or TAG:Ce. While the blue LED chip emits blue light, the yellow phosphor is suitable for being excited by the blue light to emit yellow light.

While the blue LED chip emits blue light and the yellow phosphor is excited by the blue light to emit yellow light, the LED light source device can provide required white light by blending the blue light and the yellow light. However, in existing technology of fabricating LED device, the material of the yellow phosphor is usually YAG:Ce or TAG:Ce. Thus, presently, the material of the phosphor that can be used to replace the two materials described above has become a topic of great interest for both the industries and the academic institutes.

### SUMMARY OF THE INVENTION

Accordingly, the present invention is directed to provide a phosphor suitable for being excited by a light to emit a light within a particular range of wavelengths.

According to another aspect of the present invention, a fluorescent gel having a plurality of phosphors is provided, the phosphors are suitable for being excited by a light to emit a light within a particular range of wavelengths.

According to yet another aspect of the present invention, a light emitting diode (LED) device including the fluorescent gel for providing a light of a particular color is provided.

The present invention provides a phosphor, and the general chemical formula of the phosphor comprises Me₃₋ₐYO_{5-b}X_{b}:aCe, the Me is one of calcium (Ca), strontium (Sr), barium (Ba), europium (Eu), terbium (Tb), or the combination thereof; Y is one of silicon (Si), boron (B), aluminum (Al), or the combination thereof; X is fluorine (F), chlorine (Cl), bromine (Br), or nitrogen (N); coefficient a is between 0.001 and 0.5; coefficient b is between 0 and 5.

The present invention provides a fluorescent gel, which includes a transparent material and a plurality of first phosphors. The first phosphors are doped in the transparent material. The general chemical formula of the phosphors comprises Me₃₋ₐYO_{5-b}X_{b}:aCe, the Me is one of calcium (Ca), strontium (Sr), barium (Ba), europium (Eu), terbium (Tb), or the combination thereof; Y is one of silicon (Si), boron (B), aluminum (Al), or the combination thereof; X is fluorine (F), chlorine (Cl), bromine (Br), or nitrogen (N); coefficient a is between 0.001 and 0.5; coefficient b is between 0 and 5.

The present invention provides a LED device, which includes a carrier, a LED chip, and a fluorescent gel. The LED chip is disposed on the carrier and is electrically connected to the carrier, the LED chip is suitable for emitting a first light. The fluorescent gel is disposed on the LED chip. The fluorescent gel includes a transparent material and a plurality of first phosphors. The first phosphors are doped in the transparent material. The general chemical formula of the phosphor comprises Me₃₋ₐYO_{5-b}X_{b}:aCe, the Me is one of calcium (Ca), strontium (Sr), barium (Ba), europium (Eu), terbium (Tb), or the combination thereof; Y is one of silicon (Si), boron (B), aluminum (Al), or the combination thereof; X is fluorine (F), chlorine (Cl), bromine (Br), or nitrogen (N); coefficient a is between 0.001 and 0.5; coefficient b is between 0 and 5.

In the present invention, the phosphor with chemical formula Me₃₋ₐYO_{5-b}X_{b}:aCe is employed, and the wavelength range of the emission spectrum of the phosphor can be adjusted by adjusting the ingredients of Me, Y, and X in the phosphor and the values of coefficients a and b.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional diagram of a light emitting diode (LED) device according to an embodiment of the present invention.

FIG. 2 is a diagram illustrating the emission spectrum of a LED device according to an embodiment of the present invention.

FIG. 3 is a diagram illustrating the emission spectrum of a LED device according to another embodiment of the present invention.

FIG. 4 is a cross-sectional diagram of a LED device according to another embodiment of the present invention.

FIGS. 4A˜4C are diagrams illustrating the emission spectrum of a LED device having second phosphors according to an embodiment of the present invention.

FIGS. 5A˜5C are diagrams illustrating the emission spectrum of a LED device having second phosphors according to another embodiment of the present invention.

FIG. 6 illustrates the emission spectrum and the excitation spectrum of a first phosphor according to the present invention.

### DESCRIPTION OF EMBODIMENTS

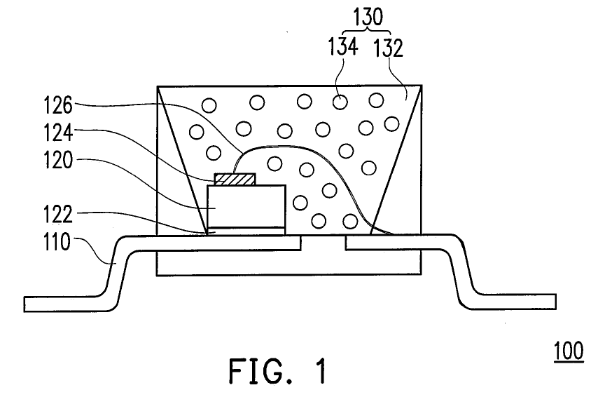

Referring to FIG. 1, according to an embodiment of the present invention, a light emitting diode (LED) device 100 includes a carrier 110, a LED chip 120, and a fluorescent gel 130. In the present embodiment, the carrier 110 is a lead frame. However, the present embodiment is not for limiting types of the carrier 110, the carrier 110 is a circuit board or other type of carrier.

The LED chip 120 is disposed on the carrier 110 and is suitable for emitting a first light, the wavelength range of the first light is between 280 nm and 480 nm, and in the present embodiment, the wavelength range of the first light is between 400 nm and 480 nm. The first electrode 122 of the LED chip 120 is disposed on the carrier 110 and is directly electrically connected to the carrier 110, while the second electrode 124 of the LED chip 120 is electrically connected to the carrier 110 through a lead 126. It is noted that the present embodiment is not for limiting the manner of the electrical connection between the LED chip 120 and the carrier 110, the first electrode 122 and the second electrode 124 are both disposed on the front of the LED chip 120, and the LED chip 120 is electrically connected to the carrier 110 through a plurality of leads 126 or other manners (such as flip chip bonding).

The fluorescent gel 130 is disposed on the LED chip 120, and is located within the illuminating area of the first light. In the present embodiment, the fluorescent gel 130 covers the LED chip 120 directly. The fluorescent gel 130 includes a transparent material 132 and a first phosphor 134. The first phosphor 134 includes the transparent material 132, and the first phosphor 134 is suitable for being excited by the first light to emit a second light. The general chemical formula of the first phosphor 134 is as shown in expression (1):

Me₃₋ₐYO_{5-b}X_{b}:aCe expression (1)

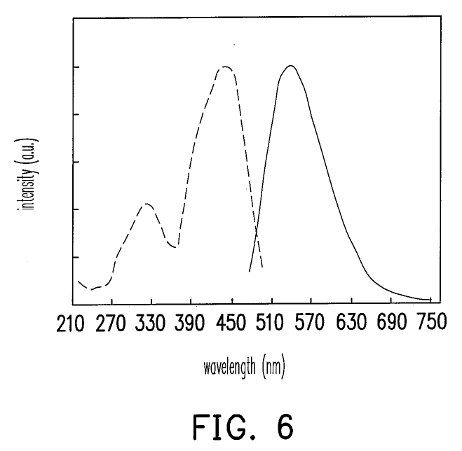

The Me is one of calcium (Ca), strontium (Sr), barium (Ba), europium (Eu), terbium (Tb), or the combination thereof; Y is one of silicon (Si), boron (B), aluminum (Al), or the combination thereof; X is fluorine (F), chlorine (Cl), bromine (Br), or nitrogen (N); coefficient a is between 0.001 and 0.5; coefficient b is between 0 and 5. As described above, the emission spectrum of the first phosphor 134 is between 460 nm and 750 nm (shown as the real line in FIG. 6), and the excitation spectrum thereof is between 280 nm and 480 nm (shown as the dotted line in FIG. 6).

It is noted that even though the emission spectrum of the first phosphor 134 is between 460 nm and 750 nm, in the present embodiment, the emission spectrum of the first phosphor 134 is adjusted within the wavelength range by adjusting the ingredient of at least one of Me, Y, and X. Besides, in the present embodiment, the emission spectrum of the first phosphor 134 is adjusted by adjusting the value of at least one of coefficients a and b. In other words, in the present embodiment, the emission spectrum of the first phosphor 134 is adjusted within the wavelength range of 460 nm to 750 nm according to the actual requirement.

As described above, the LED device 100 is employed to serve as the light source of a particular color by appropriately adjusting the colors of the first light and the second light. For example, while the first light is blue light (i.e. the LED chip 120 is InGaN-based LED chip or other LED chip which emits blue light), the first phosphor 134 is excited by the first light to emit a second light, which is yellow light. Accordingly, the LED device 100 is employed to serve as a white light source by blending the first light (blue light) and the second light (yellow light) appropriately.

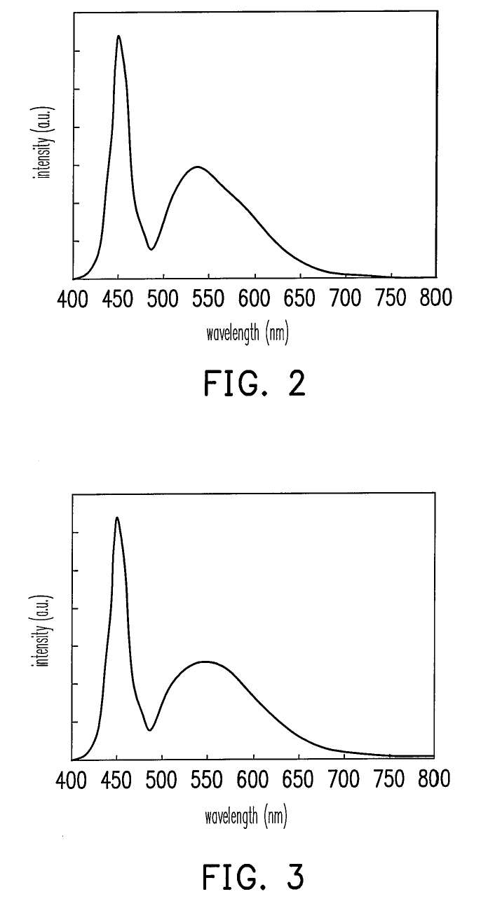

FIG. 2 is a diagram illustrating the emission spectrum of the LED device 100 according to the present embodiment. The LED chip 120 is an InGaN-based LED chip (blue light) with 450 nm main peak, and the chemical formula of the first phosphor 134 is Sr_{2.95}(Si,B,Al)O_{5-b}F_{b}:0.05Ce (yellow light). FIG. 3 is a diagram illustrating the emission spectrum of the LED device 100 according to the present embodiment, the LED chip 120 is an InGaN-based LED chip (blue light) with 450 nm main peak, and the chemical formula of the first phosphor 134 is (Sr,Ba)_{2.95}(Si,B)O_{5-b}F_{b}:0.05Ce (yellow light). It is understood from the testing results as shown in FIG. 2 and FIG. 3 that while the LED chip 120 emits blue light, the first phosphor 134 of the present embodiment is suitable for being excited by the blue light to emit yellow light, and the LED device 100 emits white light by blending the blue light and the yellow light.

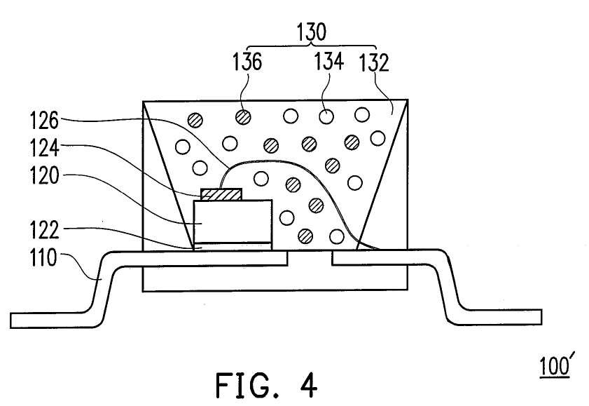

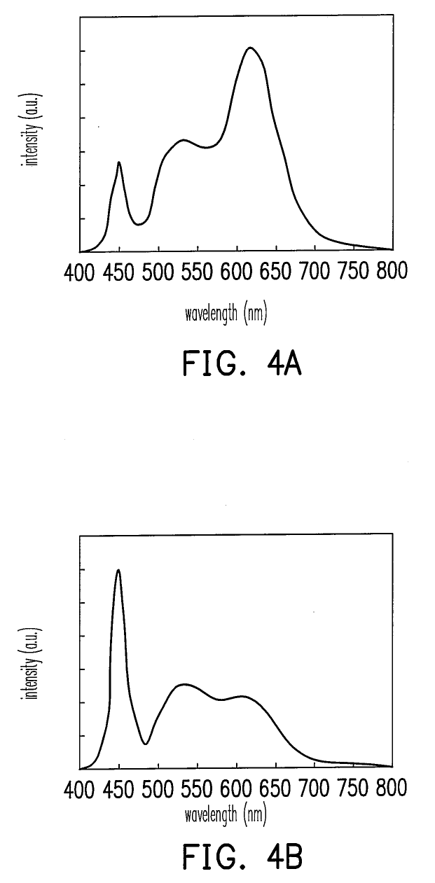

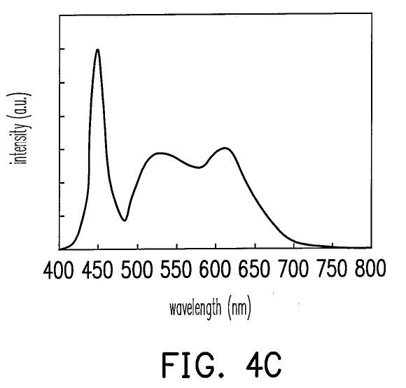

In addition, according to another embodiment of the present invention, other types of phosphors are further added into the transparent material 132, as shown in FIG. 4. The main difference between the LED device 100′ and the LED device 100 is that the fluorescent gel 130 further includes a second phosphor 136, the second phosphor 136 is suitable for being excited by the first light to emit a third light. Accordingly, in the present embodiment, the LED device 100′ is employed to serve as a white light source by adjusting the colors of the first light, the second light, and the third light appropriately. The second phosphor 136 is sulfide red emission phosphor or nitride red emission phosphor. The chemical formula of the second phosphor is SrCaS:Eu or (Sr,Ca)₂Si₅N₈:Eu.

For example, in the present embodiment, the quality of the color light emitted by the LED device 100′ is improved by choosing different type of second phosphor. In the present embodiment, while the first light emitted by the LED chip 120 is blue light, the second light emitted by the first phosphor 134 at the excitation of the first light is yellow light by adjusting the ingredients of the first phosphor 134, and moreover, the third light emitted by the second phosphor 136 by the excitation of the first light is red light by choosing appropriate second phosphor 136. Accordingly, besides serving as a white light source, the color temperature of white light of the LED device 100′ is adjusted through the blending of the first light (blue light), the second light (yellow light), and the third light (red light).

FIGS. 4A˜4C are diagrams illustrating the emission spectrum of the LED device 100′ according to the present embodiment, the LED chip 120 is an InGaN-based LED chip (blue light) with 450 nm main peak, the chemical formula of the first phosphor 134 is (Sr,Ba)_{2.95}(Si,B,Al)O_{5-b}F_{b}:0.05Ce (yellow light), the second phosphor 136 is sulfide red emission phosphor with chemical formula SrCaS:Eu (red light), and the proportions of the second phosphor 136 in FIGS. 4A˜4C are all different, the second phosphor 136 in FIG. 4A has the highest proportion and the second phosphor 136 in FIG. 4B has the lowest proportion. According to the testing results, the color temperature of the white light in FIG. 4A is 2937K, the rendering index Ra thereof is 94.5, the color temperature of the white light in FIG. 4B is 6621 K, the Ra thereof is 89.3, and the color temperature of the white light in FIG. 4C is 5257K, and the Ra thereof is 91.6. It is understood from the testing results that the LED device 100′ in the present invention can have white lights of different color temperatures through adjusting the proportion of the second phosphor 136, and all the white lights of different proportions all have high rendering index with Ra>89.

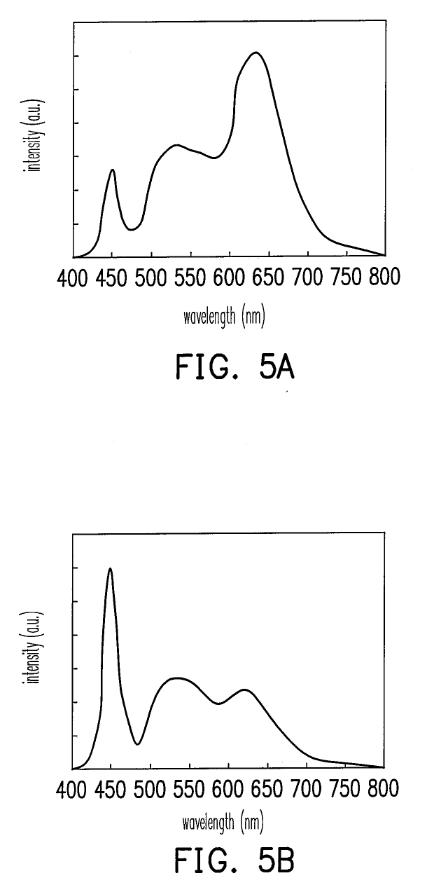

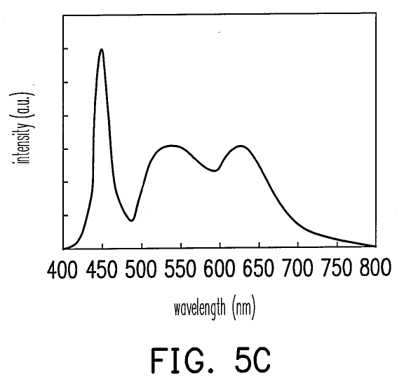

FIGS. 5A˜5C are diagrams illustrating the emission spectrum of the LED device 100′ according to the present embodiment, the LED chip 120 is a InGaN-based LED chip (blue light) with 450 nm main peak, the chemical formula of the first phosphor 134 is (Sr,Ba)_{2.95}(Si,B,Al)O_{5-b}F_{b}:0.05Ce (yellow light), the second phosphor 136 is nitride red emission phosphor with chemical formula (Sr,Ca)₂ Si₅N₈:Eu (red light), and the proportions of the second phosphor 136 in FIGS. 5A˜5C are all different. According to the testing results, the color temperature of the white light in FIG. 5A is 2975 K, the Ra thereof is 89.4, the color temperature of the white light in FIG. 5B is 6608 K, the Ra thereof is 90.2, and the color temperature of the white light in FIG. 5C is 5640K, and the Ra thereof is 91.1. It is understood from the testing results that the LED device 100′ in the present invention has white lights of different color temperatures through adjusting the proportion of the second phosphor 136, and all the white lights of different proportions all have high rendering index with Ra>89.

It is understood from the testing results shown in FIGS. 4A˜4C and FIGS. 5A˜5C, in the present embodiment, while the LED chip 120 emits blue light, besides obtaining white light through blending the blue light and the yellow light emitted by the first phosphor 134, the color temperature of the white light is further adjusted through adding appropriate second phosphor 136 which emits red light.

In overview, the present invention provides a phosphor having the chemical formula Me₃₋ₐYO_{5-b}X_{b}:aCe has the following advantages.

1. The emission spectrum of the phosphor has different wavelength range through adjusting the ingredient of at least one of Me, Y, and X in the phosphor.

2. The emission spectrum of the phosphor has different wavelength range through adjusting the value of at least one of the coefficients a and b in the phosphor.

3. Since the phosphor is excited by a light to emit yellow light, the phosphor in the present invention replaces the two yellow phosphors YAG:Ce and TAG:Ce in the conventional technology and is applied to LED devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A phosphor, the chemical formula of the phosphor being Me₃₋ₐYO_{5-b}X_{b}:aCe, the Me comprises calcium (Ca), strontium (Sr), barium (Ba), europium (Eu), terbium (Tb), or a combination thereof; Y comprises silicon (Si), boron (B), aluminum (Al), or a combination thereof; X comprises fluorine (F), chlorine (Cl), bromine (Br), or nitrogen (N); coefficient a has a value in a range between 0.001 and 0.5; coefficient b has a value in a range between 0 and 5.

2. The phosphor as claimed in claim 1, wherein an emission spectrum of the phosphor is between 460 nm and 750 nm.

3. The phosphor as claimed in claim 1, wherein the phosphor is suitable for being excited by a first light, wherein the wavelength of the first light is between 280 mm and 480 nm.

4. A fluorescent gel, comprising:
a transparent material; and
a plurality of first phosphors, doped in the transparent material, wherein a chemical formula of each of the phosphors is Me₃₋ₐYO_{5-b}X_{b}:aCe, wherein, Me comprises calcium (Ca), strontium (Sr), barium (Ba), europium (Eu), terbium (Tb), or a combination thereof; Y comprises silicon (Si), boron (B), aluminum (Al), or a combination thereof; X comprises fluorine (F), chlorine (Cl), bromine (Br), or nitrogen (N); coefficient a has a value in a range between 0.001 and 0.5; coefficient b has a value in a range between 0 and 5.

5. The fluorescent gel as claimed in claim 4, wherein an emission spectrum of the phosphor is between 460 nm and 750 nm.

6. The fluorescent gel as claimed in claim 4, wherein the phosphor is suitable for being excited by a first light to emit a second light, wherein the wavelength of the first light is between 280 nm and 480 nm.

7. The fluorescent gel as claimed in claim 4 further comprising a plurality of second phosphors doped in the transparent material, wherein the second phosphors are suitable for being excited by a light to emit a third light.

8. The fluorescent gel as claimed in claim 7, wherein the third light is red light.

9. The fluorescent gel as claimed in claim 8, wherein the second phosphor is a sulfide red emission phosphor or a nitride red emission phosphor.

10. The fluorescent gel as claimed in claim 9, wherein a chemical formula of the second phosphors comprises SrCaS:Eu or (Sr,Ca)₂Si₅N₈:Eu.

11. A light emitting diode (LED) device, comprising:
a carrier;
a LED chip, disposed on the carrier and electrically connected to the carrier, wherein the LED chip is suitable for emitting a first light; and
a fluorescent gel, disposed on the LED chip, the fluorescent gel comprising:
a transparent material; and
a plurality of first phosphors, doped in the transparent material, the first phosphors being suitable for being excited by the first light to emit a second light, wherein a chemical formula of each of the phosphors is Me₃₋ₐYO_{5-b}X_{b}:aCe, Me comprises calcium (Ca), strontium (Sr), barium (Ba), europium (Eu), terbium (Tb), or a combination thereof; Y comprises silicon (Si), boron (B), aluminum (Al), or a combination thereof; X comprises fluorine (F), chlorine (Cl), bromine (Br), or nitrogen (N); coefficient a has a value in a range between 0.001 and 0.5; coefficient b has a value in a range between 0 and 5.

12. The LED device as claimed in claim 11, wherein the first light is blue light, the second light is yellow light.

13. The LED device as claimed in claim 11 further comprising a plurality of second phosphors doped in the transparent material, wherein the second phosphors are suitable for being excited by the first light to emit a third light.

14. The LED device as claimed in claim 13, wherein the first light is blue light, the second light is yellow light, and the third light is red light.

15. The LED device as claimed in claim 14, wherein the second phosphors are sulfide red emission phosphors or nitride red emission phosphors.

16. The LED device as claimed in claim 15, wherein a chemical formula of the second phosphors comprises SrCaS:Eu or (Sr,Ca)₂Si₅N₈:Eu.

17. The LED device as claimed in claim 11, wherein the carrier is a lead frame or a circuit board.

18. The LED device as claimed in claim 11, wherein the LED chip is an InGaN-based LED chip.
